(19) United States
(12) Patent Application Publication
(10) Pub. No.: US 2026/0137058 A1
(43) Pub. Date: May 21, 2026

(54) APPLICATOR FOR ANIMAL IDENTIFICATION TAGS

(71) Applicant: SHEARWELL DATA LIMITED, MINEHEAD (GB)

(72) Inventors: Sam Webber, MINEHEAD (GB); Mike Fletcher, MINEHEAD (GB); Thomas Bleloch, MINEHEAD (GB)

(73) Assignee: SHEARWELL DATA LIMITED, MINEHEAD, EN (GB)

(21) Appl. No.: 19/383,925

(22) Filed: Nov. 10, 2025

(30) Foreign Application Priority Data
Nov. 18, 2024 (GB) 2416901.3

(51) Int. Cl. A01K 11/00

(52) U.S. Cl. CPC A01K 11/002

(57) ABSTRACT

An applicator for animal identification tags includes a tag magazine configured to hold a plurality of animal identification tags that are connected together in a strip and arranged in a row between a first end and a second end of the tag magazine. A pair of jaws receives one of the plurality of animal identification tags dispensed from the tag magazine and are operable to affix the received animal identification tag to an animal's ear by engaging a male portion and female portion of the animal identification tag through the animal's ear. The tag magazine is movable relative to the jaws to sequentially align each one of the plurality of tags in the magazine with a tag receiving portion of the jaws. The applicator includes a dispensing mechanism to dispense the one of the plurality of animal identification tags that is aligned with the tag receiving portion of the jaws.

### CROSS-REFERENCE

This application claims the benefit of priority from Great Britain Patent Application No. 2416901.3, filed Nov. 18, 2024, which is hereby incorporated by reference as if set forth in its entirety herein.

### FIELD OF THE INVENTION

The present invention relates to an applicator for animal identification tags.

### BACKGROUND

It is well known in the field of animal identification to provide an identification tag, typically attached to the animal's ear. Such tags may comprise two parts (such as a male part and female part) which interlock with one part passing through the animal's ear. Alternatively, a tag may be formed with a flexible connection between the two interlocking parts, i.e. as a single unit.

In order to attach tags to an animal, an applicator is used which typically drives a spiked male part of the tag through the animal's ear to engage with a female part of the tag on the other side to securely affix the tag to the animal. An applicator usually includes a pair of pivotable jaws which define a gap for receiving the animals ear, and which can be brought together to engage the tag parts through the animal's ear. Many applicators used to apply tags to animals only accept one tag and must be re-loaded after each tag is applied to the animal. This is time consuming and can be intricate or awkward to perform and may result in loss of tags if they are dropped while the user is trying to load a new tag into the applicator.

The present invention has been devised in light of the above considerations.

### SUMMARY OF THE INVENTION

The invention represents a development of the tag applicator described in the applicant's earlier patent GB2570340B, which is incorporated herein by reference. At its most general, the invention provides a tag applicator having a tag magazine configured to hold a strip of animal identification tags, where the tag magazine is movable relative to jaws of the applicator such that each tag in the strip can be sequentially dispensed into the jaws for tagging an animal. This facilitates rapid loading of the tag magazine, as an entire strip of tags can be loaded into the tag magazine without having to separate the tags in the strip. Moreover, keeping the animal identification tags connected in a strip enables the tag magazine to be more compact, thus improving handling of the tag applicator. This may also contribute to increasing a speed with which tagging can be performed, as a distance travelled by the magazine relative to the jaws for sequentially dispensing the tags may be reduced.

According to a first aspect, the invention provides an applicator for animal identification tags, the applicator comprising: a tag magazine configured to hold a plurality of animal identification tags that are connected together in a strip, such that the plurality of animal identification tags is arranged in a row between a first end and a second end of the tag magazine; a pair of jaws arranged to receive one of the plurality of animal identification tags dispensed from the tag magazine, the jaws being operable to affix the received animal identification tag to an animal's ear by engaging a male portion and female portion of the animal identification tag through the animal's ear; wherein the tag magazine is movable relative to the jaws along a first direction linking the first end and the second end of the tag magazine, to sequentially align each one of the plurality of tags in the magazine with a tag receiving portion of the jaws; and a dispensing mechanism operable to dispense, from the tag magazine into the tag receiving portion of the jaws, one of the plurality of animal identification tags that is aligned with the tag receiving portion of the jaws.

The tag magazine is configured to hold the plurality of animal identification tags connected together in a strip. In other words, the animal identification tags remain connected together in a strip when they are loaded into the tag magazine. Thus, the plurality of animal identification tags can be loaded into the tag magazine in a single action, i.e. the tags do not need to be separated or individually loaded into the tag magazine. This facilitates loading of the tag magazine, for example enabling more rapid loading of the tag magazine.

The tag magazine may be arranged to hold a strip of a predetermined size, i.e. comprising a predetermined number of tags that are connected together.

By keeping the plurality of animal identification tags connected together in the tag magazine, a space occupied by the plurality of animal identification tags in the tag magazine may be reduced, e.g. as compared to a tag applicator where each tag is loaded into an individual compartment. This may contribute to reducing a size of the tag magazine, in turn contributing to improved handling of the tag applicator.

The tag magazine may comprise any suitable structure for holding the strip of animal identification tags. For example, the tag magazine may comprise a holder, or compartment, in which the plurality of animal identification tags is received. Holding a strip of animal identification tags may contribute to simplifying a structure of the tag magazine, as individual holders for each tag may not be required.

The tag magazine is arranged to hold the plurality of animal identification tags in a (straight) row between the first end and the second end of the tag magazine. Thus, the plurality of animal identification tags may be arranged in a linear fashion within the tag magazine, i.e. such that the animal identification tags are (substantially) aligned with one another along the first direction. Holding the tags in a row may avoid bending or putting stresses on connections between the tags that hold the tags together in the strip. This may ensure that the tags remain connected in a strip after being loaded into the tag magazine, so that they are held in place relative to one another.

Each of the plurality of animal identification tags comprises a male portion and a female portion which are engageable with one another to attach the tag to an animal's ear. The male portion may comprise a stem (or spike) which is arranged to pass through the animal's ear to engage with the female portion of the tag. Each animal identification tag may further comprise a flexible connection portion which connects (e.g. extends between) the male portion and the female portion of the tag.

The plurality of animal identification tags are connected together to form a strip. Thus, the animal identification tags are arranged next to one another, with connections formed between adjacent animal identification tags to hold them together. For example, one or more connectors may connect adjacent animal identification tags together. The one or more connectors may continue to hold the strip together after loading into the tag magazine.

The pair of jaws may define a tag affixing gap between them into which an ear of an animal can be inserted.

The jaws may be movable relative to one another in order to open and close the tag affixing gap. In other words, the jaws may be movable between an open position and a closed position, where the tag affixing gap is larger in the open position than in the closed position. In some examples, the jaws may be pivotable relative to one another in order to open and close the tag affixing gap. Any suitable mechanism may be provided for moving the jaws relative to one another. For example, each jaw may be attached to a respective handle, such that when the handles are squeezed together, the tag affixing gap is closed. In another example, a trigger may be provided which causes one of the jaws to move relative to the other one. When the jaws are operated by a user, a tag which is situated in the gap is connected across the gap, by causing the male portion of the tag to be driven across the gap to engage with the female portion of the tag. When an animal's ear is inserted into the tag affixing gap, such operation of the jaws causes the tag to be affixed to the animal's ear, e.g. by driving the (e.g. spiked) male portion of the tag through the ear and engaging it with the female portion on the other side of the ear.

The jaws may be shaped such that the tag is held in position in the tag affixing gap whilst it is being affixed to an animal's ear.

The jaws may be biased towards an open configuration, i.e. a configuration where the gap between the jaws is open so that an animal's ear may be inserted between the jaws.

The tag receiving portion of the jaws is a portion of the jaws which is arranged to receive an animal identification tag dispensed from the tag magazine. For example, the tag receiving portion may be a slot in one of the jaws which is shaped to receive the tag. In some examples, the tag receiving portion may be located directly in the tag affixing gap between the jaws. In other examples, the tag receiving portion may form a passageway between the tag magazine and the tag affixing gap formed between the jaws. In such an example, the dispensing mechanism may further serve to convey the tag along the tag receiving portion until it reaches the tag affixing gap where it can be affixed to an animal's ear.

An opening may be provided in the jaws through which the tag can be conveyed, in order for it to be dispensed into the tag affixing gap between the jaws.

The tag magazine is movable relative to the jaws in the first direction which links the first and second ends of the tag magazine. In other words, the tag magazine is linearly movable (e.g. translatable) along the first direction relative to the jaws. Such linear movement of the tag magazine relative to the jaws may facilitate rapid dispensing of the tags from the tag magazine, enhancing a speed of operation of the tag applicator. As the plurality of animal identification tags is arranged in a row between the first and second ends of the tag magazine, motion of the tag magazine along the first direction enables each tag to be aligned in turn with the tag receiving portion of the jaws. In other words, the row of tags extends in the first direction, such that the tag magazine is movable along a direction of the row.

The tag magazine may be manually movable relative to the jaws in the first direction. Additionally or alternatively, the tag applicator may be configured to automatically move the tag magazine, e.g. in response to operation of the jaws.

The tag magazine may be movable between a first position where a first one of the plurality of animal identification tags located at the first end of the tag magazine is aligned with the tag receiving portion of the jaws, and a second position where a second one of the plurality of animal identification tags located at the second end of the tag magazine is aligned with the tag receiving portion of the jaws. The first tag may be at a first end of the strip, and the second tag may be at a second, opposite end of the strip. In this manner, the tag magazine can be moved from one end to the other relative to the jaws, to align each of the animal identification tags in the strip with the tag receiving portion of the jaws.

The first direction may be at a non-zero angle relative to a longitudinal direction of the tag applicator, e.g. so that the tag magazine crosses the longitudinal direction of the tag applicator. For example, the first direction may be (substantially) normal to the longitudinal direction of the tag applicator. In this manner, the tag magazine can be moved (translated) across the tag applicator in the first direction, to sequentially align each of the animal identification tags with the tag receiving portion of the jaws.

The longitudinal direction of the tag applicator may correspond to a longitudinal direction of the jaws, e.g. to a direction linking a proximal end of the jaws to a distal end of the jaws. For example, the longitudinal direction may correspond to a direction of the jaws normal to an axis about which the jaws are pivotable relative to one another. Additionally or alternatively, the longitudinal direction of the applicator may correspond to a longitudinal direction of a handle of the tag applicator.

Herein, an animal identification tag in the tag magazine is said to be “aligned” with the tag receiving portion of the jaws if the dispensing mechanism can dispense a tag from the tag magazine into the tag receiving portion of the jaws.

The dispensing mechanism serves to dispense a tag from the tag magazine into the tag receiving portion of the jaws. The dispensing mechanism may be manually operable, such that when a tag is aligned with the tag receiving portion of the jaws, a user can operate the dispensing mechanism to dispense the tag from the tag compartment into the tag receiving portion of the jaws, so that the tag can be applied to an animal's ear. In other examples, the dispensing mechanism may be configured to automatically dispense the tag from the tag magazine when the tag is aligned with the tag receiving portion.

The dispensing mechanism may be configured to separate (or disconnect) the tag from the strip when dispensing the tag into the tag receiving portion of the jaws. For example, the dispensing mechanism may be configured to act on the tag that is aligned with the tag receiving portion, to separate the tag from the strip and dispense the tag into the tag receiving portion. Thus, the tag may be broken off the strip as part of the dispensing performed by the dispensing mechanism. For instance, where one or more connectors connect the tag to an adjacent tag in the strip, the one or more connectors may be broken when the tag is dispensed into the tag receiving portion of the jaws.

The tag magazine may comprise a planar outer wall arranged to engage a support surface of the tag applicator, and to slide over the support surface when the tag magazine is moved relative to the jaws. Such sliding engagement between the tag magazine and the support surface of the tag applicator may facilitate rapid and accurate motion of the tag magazine relative to the jaws. In particular, engagement between the planar outer wall of the tag magazine and the support surface may serve to support and guide linear motion of the tag magazine relative to the jaws.

The planar outer wall may extend in the first direction, e.g. between the first end and the second end of the tag magazine, such that it may be (substantially) flat. The outer wall may form part of the support structure that holds the plurality of animal identification tags. A surface of the outer wall may be arranged for engagement with the support surface of the tag applicator. The surface of the outer wall may be smooth, to reduce friction with the support surface as the tag magazine is moved. Alternatively, the surface of the outer wall may have various surface profiles and/or textures. The outer wall may be continuous between the first end and the second end of the tag magazine, and/or have one or more apertures.

The support surface of the tag applicator may be adjacent to the tag receiving portion of the jaws. The support surface may be (substantially) planar, e.g. to promote smooth movement of the tag magazine relative to the jaws.

The tag magazine may comprise a pair of parallel plates between which a space for receiving the plurality of animal identification tags is defined. This provides a compact structure for holding the strip of tags, which facilitates linear movement of the tag magazine along the first direction relative to the jaws. The space between the pair of parallel plates may be a continuous space, so as to receive the whole strip of tags. In other words, the space may not be divided into compartments for individual tags. The pair of parallel plates may extend in the first direction, e.g. between the first end and the second end of the tag magazine.

Each of the plates may be continuous (e.g. so as to define a continuous wall), or may have one or more apertures.

The space for receiving the plurality of animal identification tags may be bounded by a first sidewall at the first end and by a second sidewall at the second end of the tag magazine. In other words, the first sidewall may extend between the pair of parallel plates at the first end, and the second sidewall may extend between the pair of parallel plates at the second end of the tag magazine. Thus, for example, the space for receiving the plurality of animal identification tags may have a rectangular shape, bounded by the pair of parallel plates and the first and second sidewalls.

A first one of the pair of parallel plates may correspond to the outer wall described above.

The tag magazine may comprise a first inner surface and a second inner surface which are mutually opposed, and between which the plurality of animal identification tags is received in use, wherein the first inner surface is arranged to contact a male portion of each of the animal identification tags, and the second inner surface is arranged to contact a female portion of each of the animal identification tags. In this manner, the strip of tags may be held between the first inner surface and the second inner surface of the tag magazine. Contact between the male portion of the tags and the first inner surface, and between the female portion of the tags and the second inner surface, may serve to retain the strip of tags within the tag magazine, e.g. via friction. The connection portion between the male and female portions of each tag may be bent so that the male and female portions of the tag are arranged opposite one another. The connection portion of the tags may be formed of a resilient material which acts to press the male and female portions against the first inner surface and second inner surface, respectively, to thereby hold the tags in the tag magazine via friction with the first and second inner walls. When loading the strip into the tag magazine, the connection portion of each tag may be bent to arrange the male portion and the female portion opposite one another and enable insertion of the strip into the tag magazine.

As the first inner surface and the second inner surface are mutually opposing, the male portion and the female portion of each tag may be arranged opposite one another when loaded into the tag magazine. In this manner, when a tag is dispensed into the tag receiving portion of the jaws, the male and female portion may already be arranged opposite one another for attachment to the animal's ear.

The first inner surface and the second inner surface be on a first one and a second one of the pair of parallel plates mentioned above, respectively.

A gap, or space, is defined between the first inner surface and the second inner surface for receiving the plurality of animal identification tags.

The first inner surface and the second inner surface may be smooth. Alternatively, one or both of the first inner surface and the second inner surface may comprise surface features for engagement with the plurality of animal identification tags, e.g. to locate the tags within the tag magazine and/or retain the tags within the tag magazine.

The tag magazine may be arranged to hold the plurality of animal identification tags such that for each tag, the male portion is partially engaged in the female portion. This may contribute to reducing a size of the tag magazine, by storing the animal identification tags in a more compact state. For example, in line with the discussion above, the animal identification tags may be stored such that the male and female engagement portion of each tag are arranged opposite with one another, such that they are partially engaged. By only partially engaging the male and female portions, the male and female portions can move apart when the tag is dispensed into the jaws, to allow for attachment to the animal's ear. In particular, when the male portion is only partially engaged in the female portion, it can be withdrawn from the female portion (without breaking any part of the tag). In contrast, when the male portion is fully engaged with the female portion (e.g. following attachment to the animal's ear), the male and female portion cannot be disengaged without breaking part of the tag.

The tag magazine may comprise a tag alignment feature arranged to sit between adjacent animal identification tags in the strip, such that a connector between the adjacent animal identification tags extends across the tag alignment feature. In this manner, when the strip of tags in loaded into the tag magazine, the alignment feature does not interfere with the connector(s) between adjacent tags, such that the plurality of animal identification tags can remain connected in a strip in the tag magazine. The alignment feature may serve to locate or align the plurality of animal identification tags in the tag magazine, to ensure accurate loading of the tags into the tag magazine. For example, the tag alignment feature may serve to inhibit (or restrict) movement of the strip within the tag magazine. A shape (e.g. a height) of the alignment feature may be adapted such that the connector between adjacent tags extends across (e.g. passes over) the alignment feature.

As an example, the alignment feature may comprise a protrusion or a ridge on the first inner surface and/or the second inner surface mentioned above.

The alignment feature may extend in a direction (substantially) normal to the first direction. This may facilitate alignment of the plurality of animal identification tags between the first end and the second end of the tag magazine.

The tag alignment feature may comprise a plurality of tag alignment features, each arranged to be between a respective pair of adjacent animal identification tags in the strip. The plurality of tag alignment features may define a plurality of tag receiving spaces, each tag receiving space being configured to hold a respective one of the plurality of animal identification tags, and wherein a respective tag alignment feature is arranged between each pair of adjacent tag-receiving spaces.

The tag alignment feature may comprise a first portion extending on the first inner surface and a second portion extending on the second inner surface; the first portion and the second portion of the alignment feature may be connected together in a first region; and there may be a gap between the first portion and the second portion of the alignment feature in a second region. Thus, in the first region, the tag alignment feature may extend between the first and second inner surfaces, and in the second region, there is a gap between first and second portions of the tag alignment features on the first and second inner surfaces. The gap may be arranged (e.g. positioned) such that the connector between the adjacent animal identification tags extends across the gap. In other words, the connector between the adjacent tags may be located in the second region of the alignment feature, such that the alignment feature does not interfere with the connector. As the alignment feature extends between the first and second inner surfaces in the first region, the first region of the alignment feature may serve to locate (e.g. position) the animal identification tags in the tag magazine.

The second region of the alignment feature may be arranged towards a loading side of the tag magazine. The loading side of the tag magazine may correspond to a side of the tag magazine via which the plurality of animal identification tags is loaded into the tag magazine. Thus, the gap between the first and second portions of the alignment feature may be located at the loading side of the tag magazine, which may facilitate loading of the strip into the tag magazine. The first region of the alignment feature may be located on a side of the tag magazine opposite to the loading, e.g. so that it does not interfere with loading of the strip into the tag magazine.

Where there is a plurality of tag alignment features, each tag alignment feature may have respective first and second regions, as described above.

The dispensing mechanism may comprise a pusher operable to push the animal identification tag that is aligned with the tag receiving portion to separate (or disconnect) the animal identification tag from the strip and dispense the animal identification tag into the tag receiving portion of the jaws. In this manner, the pushing action of the dispensing mechanism may serve to both disconnect the animal identification tag from the strip and push the animal identification tag into the tag receiving portion of the jaws. In this manner, no separate mechanism (such as a cutter or the like) may be required for separating the tag from the strip when dispensing the tag. For example, pushing of the animal identification tag may cause the tag to move relative to the rest of the strip, causing a connector between the tag and the rest of the strip to break (e.g. shear). In line with the discussion above, the animal identification tag may be connected to an adjacent tag in the strip by one or more connectors. Thus, the pusher may cause the one or more connectors to break.

The pusher may include any suitable mechanism for pushing the tag. The pusher may be extendable through the tag magazine to push the animal identification tag into the tag receiving portion of the jaws. For example, the pusher may comprise a rod (or shaft) that is extendable through the tag magazine. The rod may be movable along its length relative to the jaws, so as to extend into the tag magazine to push the tag. The pusher may be extendable (movable) along the longitudinal direction of the jaws.

The tag magazine may comprise an opening (or aperture) through which the pusher is extendable to push the tag into the tag receiving portion of the jaws. In some cases, the tag magazine may comprises a plurality of openings, each opening associated with a respective one of the plurality of animal identification tags. The pusher can then be extended through the opening in the tag magazine associated with the tag, to dispense the tag into the tag receiving portion of the jaws.

The tag applicator may further comprise a blocking surface arranged to engage (e.g. blockingly engage) an animal identification tag in the strip adjacent to the animal tag that is aligned with the tag receiving portion, to thereby block motion of a remaining portion of the strip in a pushing direction of the pusher when the pusher is operated. In this manner, when the pusher is operated, only the tag that is aligned with the tag receiving portion of the jaws is moved in the pushing direction, with the remaining portion of the strip staying in the tag magazine. In this manner, only one tag is pushed into the jaws at a time by the pusher. This further provides for effective separation of the tag from the strip, as the tag is moved by the pusher relative to the remaining portion of the strip in the pushing direction, causing breaking of any connectors between the tag and the remaining portion of the strip. For example, this may cause one or more connectors between the tag and the adjacent tag to break (e.g. shear) due to the relative movement between the two tags.

Here, the remaining portion of the strip may correspond to one or more of the plurality of animal identification tags that remain in the tag magazine after dispensing of the tag into the tag receiving portion of the jaws.

The blocking surface may be arranged on a side of the jaws. For example, the blocking surface may extend laterally from the jaws in the first direction, so as to block motion in the pushing direction of the remaining portion of the strip. In some cases, the blocking surface may extend on either side of the jaws (along the first direction), so as to block motion in the pushing direction of tags located on either side of the jaws. In some cases, the blocking surface may comprise a surface on one or both of the jaws. For instance, an opening may be provided in one of the jaws through which the tag can be conveyed to the tag receiving portion. In such a case, a surface of the jaw around the opening may act as the blocking surface, e.g. such that the opening is dimensioned to allow only a single tag to pass into the tag receiving portion.

The tag magazine may comprise a plurality of tag receiving spaces, each tag receiving space being configured to hold a respective one of the plurality of animal identification tags; the tag magazine may comprise plurality of indexing features, each indexing feature being associated (e.g. aligned) with a respective one of the tag receiving spaces; and the applicator may comprise an engagement member, the engagement member being configured to, when the jaws are in an open position, engage the indexing feature associated with one of the tag-receiving spaces that is aligned with the tag receiving portion of the jaws. This may serve to ensure proper alignment between the tag receiving space and the tag receiving portion of the jaws. In particular, as the tag magazine is moved in the first direction, this may facilitate sequential alignment of each of the tag-receiving spaces with the tag receiving portion of the jaws. Engagement between the engagement member and one of the indexing features may also provide a visual indicator to the user that one of the tag receiving spaces in the tag magazine is aligned with the tag receiving portion of the jaws, such that a tag can be dispensed into the jaws.

With the jaws in the open position, the jaws may be arranged to receive a tag dispensed from the tag magazine. Thus, engaging the engagement member with one of the indexing features when the jaws are in the open position ensures that the jaws are ready to receive a tag from the tag magazine. The engagement member may further be configured to be disengaged from the indexing feature when the jaws are in a closed position. In this manner, when the jaws are closed (e.g. to affix a tag to an animal's ear), the engagement member is disengaged from the indexing features on the tag magazine, so that the tag magazine can be moved in the first direction to align a next tag in the strip with the tag receiving portion of the jaws.

The engagement member may be arranged to block or restrict motion of the tag magazine in the first direction when the engagement member is engaged with one of the indexing features on the tag magazine. This may improve a stability with which the tag magazine is held relative to the jaws during dispensing of a tag into the tag receiving portion of the jaws. Thus, the tag magazine may only be movable relative to the jaws when the engagement member is disengaged from the indexing features, e.g. when the jaws are moved towards the closed position.

Each of the indexing features may have a shape that is complementary to a shape of the engagement member, to facilitate engagement of the engagement member with the indexing features.

The indexing features may be arranged in a row along the first direction, e.g. along an edge or a surface of the tag magazine.

The engagement member may be connected to one of the jaws, e.g. a movable one of the jaws. In this manner the engagement member may move with the jaw as the jaws are moved between the open and closed positions.

Each of the plurality of tag receiving spaces may correspond to a space in the tag magazine within which one of the plurality of animal identification tags is received. Together, the plurality of tag receiving spaces may form a continuous space within the tag magazine, e.g. there may be no walls or dividers separating adjacent tag receiving spaces, so that the strip can be loaded as a whole into the tag magazine. In some cases, one or more alignment features may be provided in the tag magazine as described above. The alignment features may serve to define the plurality of tag receiving spaces, e.g. by defining respective positions at which each of the tags in the strip is held.

The tag applicator may further comprise an actuation mechanism, the actuation mechanism being configured to, when the jaws are operated to affix a first one of the plurality of animal identification tags to an animal's ear, cause the tag magazine to move in the first direction to align a second, adjacent one of the plurality of animal identification tags with the tag receiving portion of the jaws. Thus, when the jaws are operated to affix a tag (e.g. by closing the tag affixing gap between the jaws), the tag magazine is automatically caused to move in the first direction such that a next (adjacent) tag in the strip can be dispensed into the tag receiving portion of the jaws. Accordingly, by repeatedly operating the jaws, the actuation mechanism may cause each of the plurality of animal identification tags to be aligned in turn with the tag receiving portion of the jaws. This avoids having to manually move the tag magazine in order to dispense the next tag in the strip, and may serve to increase the rate at which tags can be affixed to animals'ears.

The actuation mechanism may comprise any suitable mechanism for converting the relative movement of the jaws into a (linear) movement of the tag magazine along the first direction.

In some cases, the actuation mechanism may comprise a ratchet mechanism configured to convert the relative movement of the jaws into movement of the tag magazine along the first direction. For example, the tag magazine may comprise a plurality (e.g. a linear array) of teeth that extends in the first direction. The ratchet mechanism may be configured to engage one of the teeth on the tag magazine when the jaws are moved towards the closed position, to move the tag magazine in the first direction.

The ratchet mechanism may comprise a pawl assembly that is configured to engage one of the teeth on the tag magazine when the jaws are moved towards the closed position, to move the tag magazine in the first direction. For example, the pawl assembly may be arranged to pivot when the jaws are moved towards the closed position, to thereby engage the tooth and move (e.g. push) the tag magazine in the first direction.

The actuation mechanism may be configured to restrict (e.g. block, prevent) movement of the tag magazine relative to the jaws when the jaws are in the closed position. In particular, the actuation mechanism may restrict forward and/or backward movement of the tag magazine along the first direction. This may prevent further movement of the tag magazine along the first direction when the jaws are closed. For example, this may avoid the tag magazine moving too far (overshooting) in the first direction, which could result, for example in one of the tags being skipped and/or misalignment of a tag with the jaws. Similarly, this may prevent the tag magazine from moving backwards after closing of the jaws, which could result in a misalignment of the tag with the jaws. Thus, when the jaws are moved towards the closed position, the tag magazine is moved in the first direction to move a next tag in the plurality of tags into alignment with the tag receiving portion of the jaws. When the jaws reach the closed position, further movement of the tag magazine relative to the jaws (in forwards and/or backwards along the first direction) is prevented, thus ensuring accurate alignment of the next tag with the tag receiving portion of the jaws.

Where the actuation mechanism comprises a ratchet mechanism, the pawl assembly may be configured to engage one of the teeth to push the tag magazine in the first direction. The pawl assembly may further comprise a blocking surface which is configured to engage another one of the teeth when the jaws are in the closed position, to thereby restrict movement of the tag magazine relative to the jaws. Thus, engagement between the blocking surface and one of the teeth acts to restrict (e.g. block) movement of the tag magazine relative to the jaws.

The blocking surface on the pawl assembly may be arranged (e.g. shaped) to be engaged in a gap between adjacent teeth on the tag magazine. Thus, the blocking surface may engage the teeth on either side of the gap. This may serve to effectively restrict forward and backward motion of the tag magazine along the first direction.

The pawl assembly may be arranged to continuously contact the tag magazine (e.g. the teeth on the tag magazine) when the jaws are moved from the open position to the closed position. This may provide controlled and accurate movement of the tag magazine in the first direction, and avoid overshooting and/or misalignment of the tags with the jaws. For example, the pawl assembly may comprise a pawl that is configured to engage one of the teeth to push the tag magazine in the first direction when the jaws are moved towards the closed position, and the blocking surface arranged to engage one or more of the teeth when the jaws are in the closed position.

The tag magazine may include a plurality of engagement portions, each engagement portion being associated with one of plurality of animal identification tags (or with one of the plurality of tag receiving spaces in the tag magazine); wherein the applicator further includes a locating element; and wherein the locating element is engageable with the engagement portions such that, when one of the animal identification tags (i.e. one of the tag receiving spaces) is aligned with the tag receiving portion of the jaws, the locating element is engaged with the engagement portion associated with that animal identification tag. When the locating element is engaged with an engagement portion of the tag magazine, the locating element may resist motion of the tag magazine along the first direction. This serves to accurately align a tag with the receiving portion of the jaws, as the tag magazine may stop moving when the locating element engages the corresponding engagement portion. This also serves to maintain alignment between the tag and the receiving portion of the jaws, and to prevent unwanted movement of the tag magazine. Thus, if the tag magazine is caused to move by the actuation mechanism, the tag magazine may stop moving when one of the tags is aligned with the tag receiving portion, due to engagement between the locating element and the engagement portion associated with that tag.

The locating element may resist motion of the tag magazine when a force below a threshold torque is applied to the tag magazine. However, the locating element's resistance to motion may be overcome by applying a force to the tag magazine which is greater than the threshold force. For example, in embodiments including an actuation mechanism, the actuation mechanism may be configured to apply a force greater than the threshold force to the tag magazine when the jaws are operated. The locating element and engagement portions may be features having complementary shapes. In some examples, the locating element may be a ball catch, and the engagement portions may be detents (e.g. grooves or cavities) in a surface of the tag magazine.

The tag magazine may be removably mounted on a body portion of the applicator. Thus, the tag magazine may be removed from the applicator so that it can be easily reloaded and/or replaced. The body portion of the applicator may be a portion of the applicator which is connected to one of the jaws. For example, the tag magazine may be mounted on a handle which is connected to one of the jaws. In further embodiments, the tag magazine may be removably mounted on the body portion via a clamp. The clamp enables the tag magazine to be easily mounted and removed from the applicator without having to use any tools.

In cases where the applicator includes a locating element, the locating element may be disposed on the clamp.

The tag magazine may comprise one or more retaining elements for retaining the plurality of animal identification tags in the tag magazine. For example, the one or more retaining elements may be arranged to block the plurality of tags from falling out of the tag magazine. Each retaining feature may be in the form of a protrusion over which one of the tags is pushed when the tag is loaded into the tag magazine. In this manner, the protrusion may block the tag from falling out of the tag magazine, e.g. due to engagement (frictional force) between the tag and the protrusion. To dispense the tag, the dispensing mechanism may be arranged to apply a force to the tag to push the tag over the protrusion. Thus, a sufficient force may be required to deform the tag to push it over the protrusion and/or to overcome a frictional force between the tag and the protrusion. According to a second aspect of the invention, there is provided an animal tagging system comprising a tag applicator according to the first aspect; and a plurality of animal identification tags connected together in a strip, wherein the tag magazine is arranged to hold the strip between the first end and the second end of the tag magazine.

The system of the second aspect may include any of the features described above in relation to the first aspect.

According to a third aspect of the invention, there is provided a tag magazine for an animal identification tag applicator; wherein the tag magazine comprises a holder for holding a plurality of animal identification tags that are connected together in a strip, such that the plurality of animal identification tags is arranged in a row between a first end and a second end of the tag magazine; wherein the tag magazine is configured to engage an actuation mechanism of the tag applicator for moving the tag magazine relative to jaws of the tag applicator along a first direction linking the first end and the second end of the tag magazine.

The tag magazine of the third aspect may be used as part of the tag applicator of the first aspect of the invention. Any of the features described in relation to the tag magazine in the first aspect of the invention are equally applicable to the tag magazine of the third aspect of the invention.

According to a fourth aspect of the invention, there is provided a method of using a tag applicator according to the first aspect of the invention, or an animal tagging system according to the second aspect of the invention. Any of the features described above in relation to preceding aspects of the invention may be applied to the method of the fourth aspect. The method comprises: loading the tag magazine with a plurality of animal identification tags that are connected together in a strip, such that the plurality of animal identification tags is arranged in a row between the first end and the second end of the tag magazine; operating the dispensing mechanism to dispense a first one of the plurality of animal identification tags into the tag receiving portion of the jaws; and moving the tag magazine relative to the jaws in the first direction, to align a second, adjacent one of the plurality of animal identification tags with the tag receiving portion of the jaws.

In line with the discussion above, the plurality of animal identification tags remain connected together as a strip following loading into the tag magazine.

Operating the dispensing mechanism may cause the first tag to be separated (e.g. disconnected) from the strip, e.g. by breaking one or more connectors between the first tag and an adjacent tag in the strip. As an example, the dispensing mechanism may comprise a pusher as described above.

In line with the discussion above, the tag magazine may be moved by an actuation mechanism, e.g. which moves the tag magazine in response to operating the jaws. Thus, the method may comprise operating the jaws (e.g. moving the jaws from an open position to a closed position), which causes the actuation mechanism to move the tag magazine relative to the jaws to align the second, adjacent tag with the tag receiving portion of the jaws. Operation of the jaws may be performed, for example, to affix the first tag the an animal's ear.

Herein, the terms “animal identification tag” and “tag” are used interchangeably.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a perspective view of an applicator for animal identification tags according to an embodiment of the invention;

FIG. 2 shows a side view of an applicator for animal identification tags according to the embodiment;

FIG. 3 shows a part cutaway side view of the applicator for animal identification tags according to the embodiment, where parts of the internal structure of the applicator are revealed;

FIG. 4 shows a cross-sectional view of the applicator for animal identification tags according to the embodiment along the B-B plane shown in FIG. 3;

FIG. 5 shows an exploded view of an actuation mechanism which is part of the applicator for animal identification tags according to the embodiment;

FIG. 6a shows a front view of a tag magazine which is part of the applicator for animal identification tags according to the embodiment;

FIG. 6b shows a front view of the tag magazine, where the tag magazine is loaded with a strip of animal identification tags;

FIG. 6c shows a cross-sectional view of the tag magazine along the A-A plane shown in FIG. 6b, revealing an arrangement of an animal identification tag in the tag magazine;

FIG. 6d shows a perspective view of the tag magazine, showing a front side of the tag magazine;

FIG. 6e shows a perspective view of the tag magazine, showing a back side of the tag magazine;

FIG. 7 shows an exploded view of the applicator for animal identification tags according to the embodiment;

FIG. 8 shows a side view of an animal identification tag before loading into the tag magazine;

FIG. 9 shows a perspective view of a strip of animal identification tags, comprising a plurality of animal identification tags arranged in a row;

FIGS. 10a and 10b show plan views of a tag magazine and cam assembly of a tag applicator according to an embodiment, where the cam assembly is in a first position and a second position, respectively.

### DETAILED DESCRIPTION OF THE INVENTION

Aspects and embodiments of the present invention will now be discussed with reference to the accompanying figures. Further aspects and embodiments will be apparent to those skilled in the art.

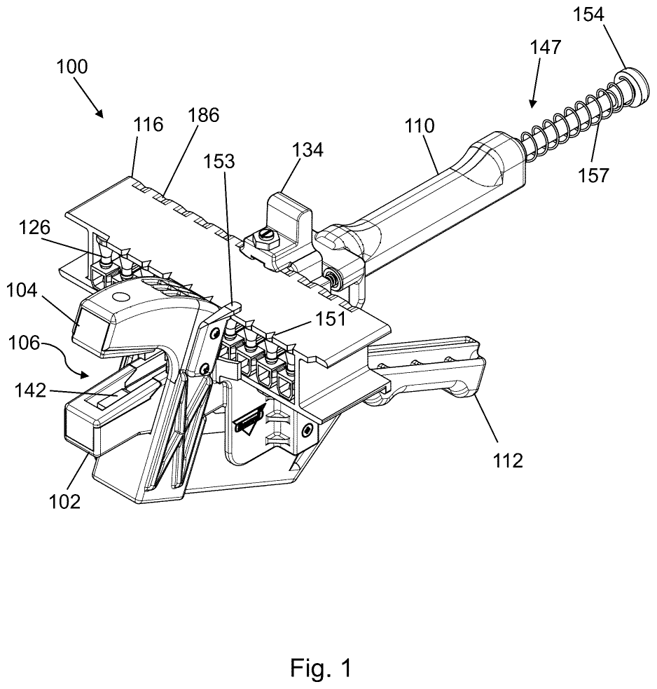

A tag applicator 100 according to an embodiment of the invention is described with reference to FIGS. 1 to 7. The applicator 100 includes a pair of jaws that are operable to affix an animal identification tag to an animal's ear, and a tag magazine configured to hold a strip of tags. The tag magazine is movable relative to the jaws, such that tags in the strip can be sequentially dispensed from the tag magazine into the jaws, where they can be affixed to an animal's ear.

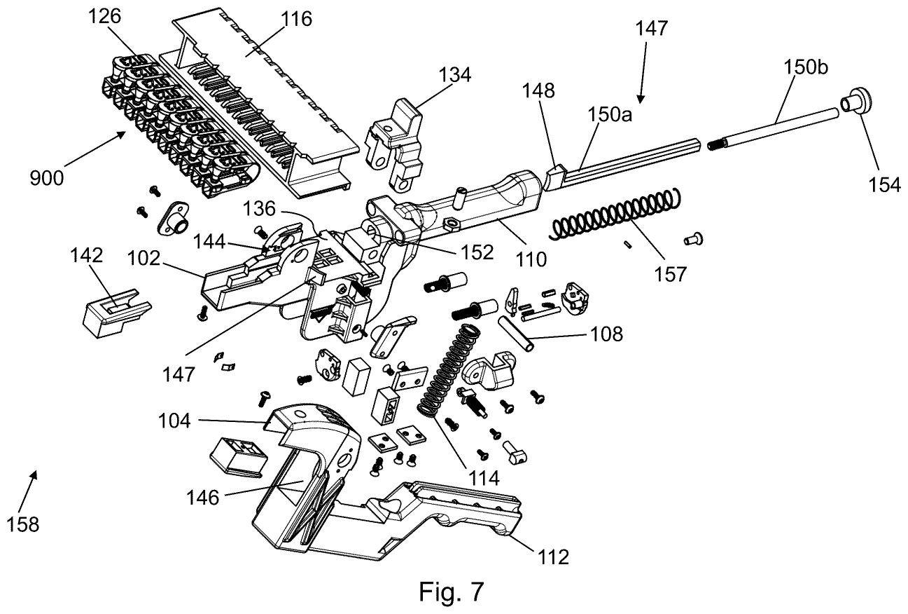

As shown in FIGS. 1-3, the applicator 100 includes a lower jaw 102 and an upper jaw 104 which are pivotable relative to one another to open and close a tag affixing gap 106 formed between the jaws. The jaws are connected together via a pivot 108, which is shown in FIG. 7. The lower jaw 102 is attached to a first handle 110, and the upper jaw 104 is attached to a second handle 112. Thus, by squeezing the first and second handles together, the jaws may be brought together to close the tag affixing gap 106 between the jaws. A main spring 114 (see FIG. 7) is provided between the first and second handles to bias them apart from one another, in order to bias the jaws towards the open configuration shown in FIGS. 1-3. The jaws are operable to clamp together so as to affix an animal identification tag located in the tag affixing gap 106 to an animal's ear, as described in more detail below.

Of course, the main spring 114 may be omitted, in which case the first and second handles can be manually moved apart from each other.

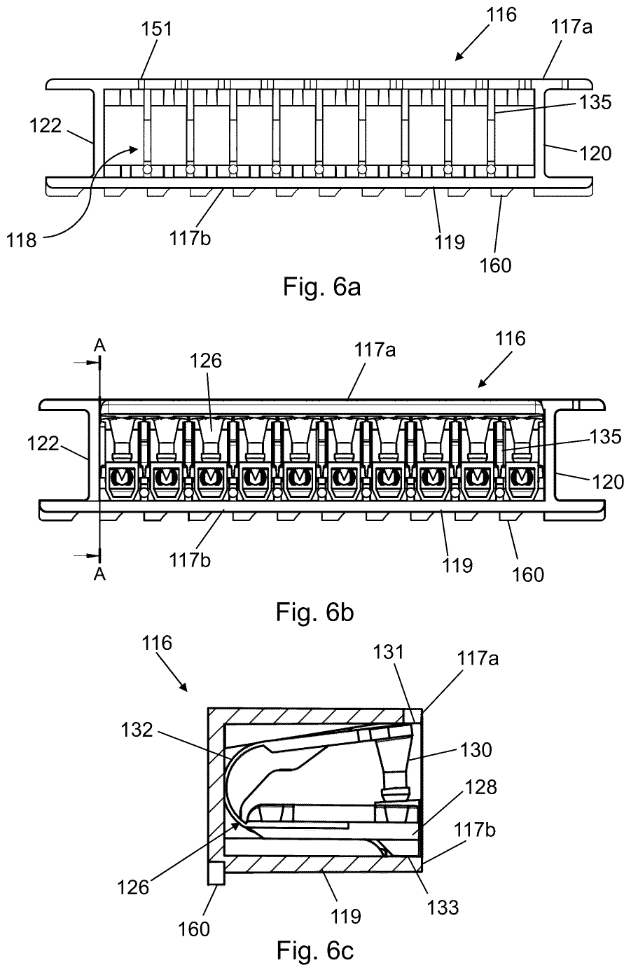

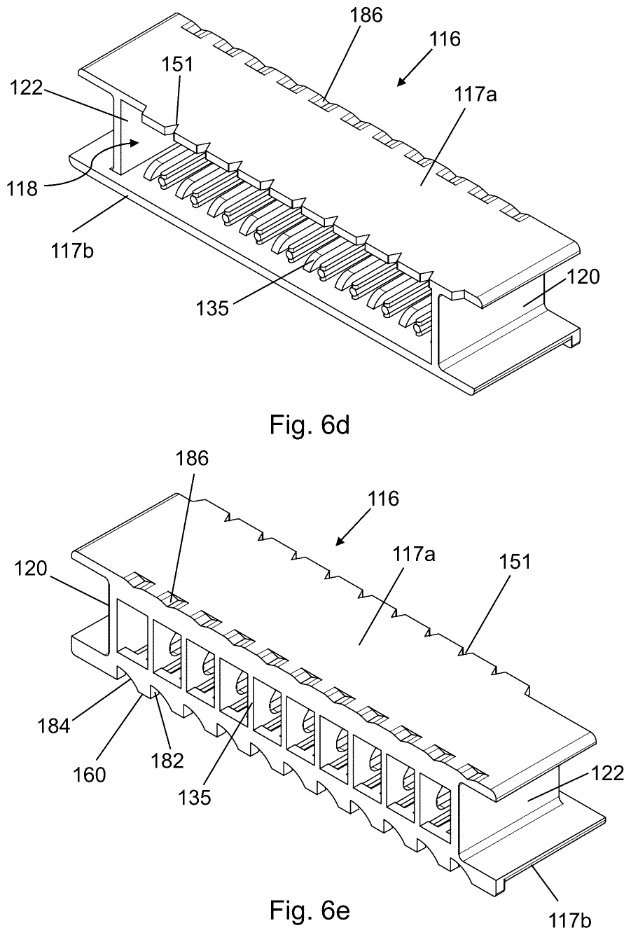

Mounted on the first handle 110 is a tag magazine 116, which is shown in greater detail in FIGS. 6a to 6e. The tag magazine 116 is configured to hold a plurality of animal identification tags 126, which are connected together in a strip. The tag magazine 116 is formed by a pair of parallel plates 117a, 117b between which a tag receiving space 118 is defined. Tag receiving space 118 extends continuously between a first sidewall 120 at a first end of the tag magazine 116, and a second sidewall 122 at a second end of the tag magazine. The tag magazine 116 is arranged to hold the strip of tags 126 such that the tags are arranged (e.g. aligned) in a row between the first end (first sidewall 120) and the second end (second sidewall 122) of the tag magazine 116.

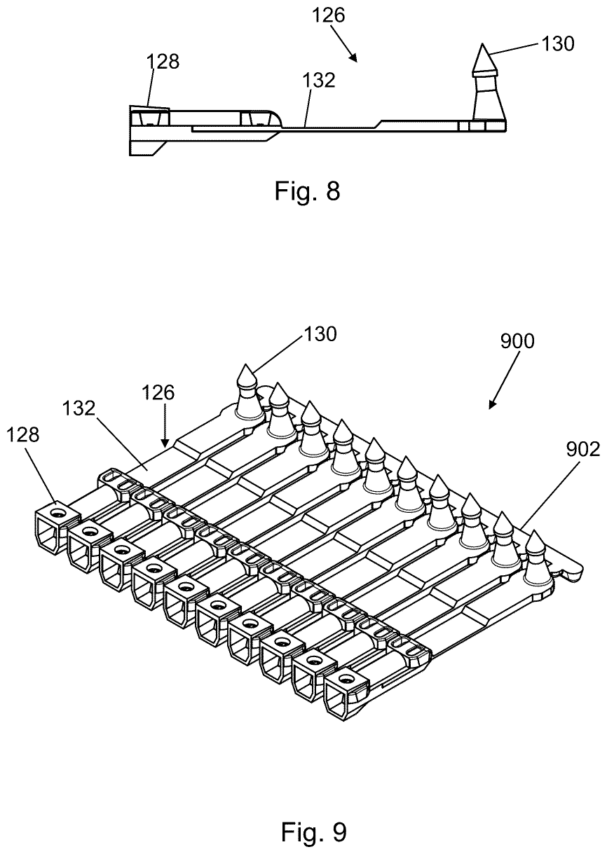

FIG. 8 shows a side view of an individual animal identification tag 126. Each tag 126 may comprise a female portion 128 and a male portion 130 which are linked (connected) by a flexible (e.g. resilient) connection portion 132. The male portion 130 is engageable with the female portion 128, such that when the male portion 130 is engaged with the female portion 128 through an animal's ear, the tag 126 is securely affixed to the animal's ear. A plurality of animal identification tags 126 may be connected together in a strip 900, as shown in FIG. 9. In this arrangement, the plurality of tags 126 are arranged next to one another in a row, and connected to one another so as to form a single unit. For example, one or more breakable (e.g. frangible) connectors may connect adjacent tags 126 in the strip 900. Additionally, a connector bar 902 may be provided along a side of the strip 900, to provide further connections between the tags 126. In the example shown, the connector bar 902 is connected to the male portion 130 of each tag 126, e.g. via respective breakable connectors.

The tag magazine 116 is arranged to hold the entire strip 900 of tags in the tag receiving space 118, with the tags 126 in the strip 900 still connected to one another. FIG. 6b shows a front view of the tag magazine 116 holding the strip 900 of tags 126. To load the strip 900 into the tag magazine, the strip 900 is folded to bend the connection portion 132 of each tag 126 such that the male portion 130 and the female portion 128 of each tag 126 are arranged opposite one another. FIG. 7 shows the strip 900 where it is folded for insertion into the tag magazine 116. The folded strip 900 of tags 126 is then loaded into the tag magazine 116 via an open front side of the tag magazine 116, such that the strip 900 of tags 126 is located in the tag receiving space 118 between the plates 117a, 117b. Where the strip 900 includes a connector bar 902, the connector bar 902 may be broken off from the strip 900 following loading of the strip 900 into the tag magazine 116.

FIG. 6c shows a section view of the tag magazine 116 following loading of the strip 900 of tags. The section of FIG. 6c is taken along the A-A plane indicated in FIG. 6b, to illustrate the arrangement of one of the tags 126 held in the tag magazine 116. As shown in FIG. 6c, the connection portion 132 of the tag 126 is bent so that the female portion 128 and the male portion 130 lie opposite to one another, with the male portion 130 being partially engaged in the female portion 128. A resilience of the connection portion 132 urges the male and female portions away from one another, which causes the male and female portions to press outwards against inner surfaces of the tag magazine. In more detail, the male portion 130 is pressed against a first inner surface 131 on the first plate 117a, and the female portion 128 is pressed against a second inner surface 133 on the second plate 117b. The first inner surface 131 and the second inner surface 133 are mutually opposing, and face one another across the tag receiving space 118. Accordingly, the strip 900 of tags 126 is held in place in the tag magazine 116 due to friction between the male and female engagement portions of the tags and the first and second inner surfaces of the tag magazine 116, respectively.

The tag magazine 116 comprises a plurality of tag alignment features 135 arranged within the tag receiving space 118, to guide insertion of the tags 126 and to restrict movement of the tags 126 in the tag magazine 116 following insertion. In more detail, the plurality of tag alignment features 135 is arranged such that a respective tag alignment feature 135 is located between each pair of adjacent tags 126 in the strip 900 following loading of the strip 900 into the tag magazine 116. The tag alignment features may, for example, be in the form of protrusions or ridges on the first inner surface 131 and/or the second inner surface 133, which serve to define or delineate a tag receiving space (or position) for each of the tags 126 in the strip 900. Thus, together, the plurality of tag alignment features 135 may define (or delineate) a plurality of tag receiving spaces (or positions), each tag receiving space being arranged to receive and hold a respective one of the tags 126 in the strip 900. The tag alignment features 135 are arranged (e.g. shaped, positioned) such that the one or more connectors between adjacent tags 126 in the strip 900 extend across the tag alignment features 135 following loading of the strip 900 into the tag magazine 116. In this manner, the tag alignment features 135 can act to guide insertion of the strip 900, whilst allowing the tags 126 to remain connected to one another.

In the example shown, each tag alignment feature 135 comprises a first portion extending on the first inner surface 131 and a second portion extending on the second inner surface 133. In a first region, towards a back side of the tag magazine 116 (shown in FIG. 6e), the first portion and the second portion of the alignment feature are connected together. In other words, the alignment feature 135 extends between the first inner surface 131 and second inner surface 133 towards the back side of the tag magazine 116. In a second region, towards the open front side of the tag magazine 116 (shown in FIG. 6d), there is a gap between the first portion and the second portion of tag alignment feature 135. In other words, the tag alignment feature does not extend between the first inner surface 131 and the second inner surface 133 towards the open front side of the tag magazine 116. The gap between the first and second portions of the tag alignment features 135 at the front side of the tag magazine 116 allows insertion of the strip 900 via the front side. The tag alignment features 135 extending between the first and second inner surfaces at the back side of the tag magazine 116 may prevent the strip 900 of tags 126 from falling out the back side of the tag magazine 116.

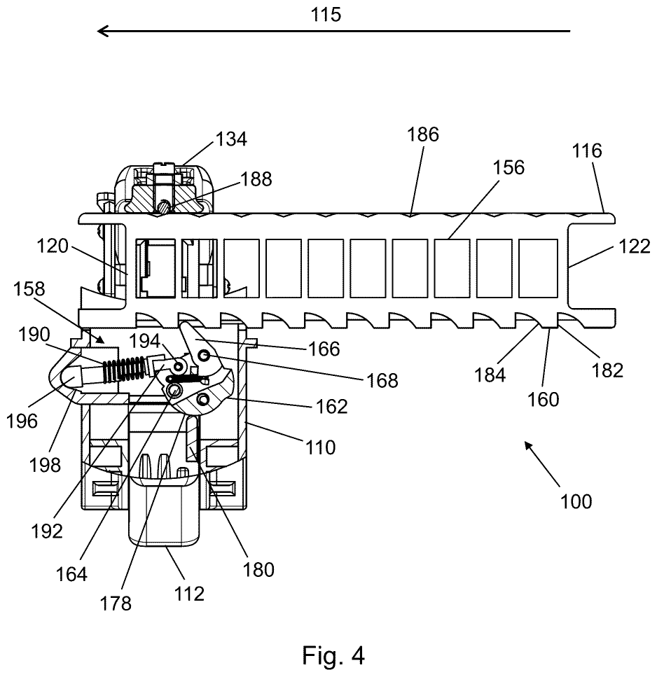

The tag magazine 116 is mounted on the first handle 110 such that it is movable relative to the jaws 102, 104 in a first direction linking the first end and the second end of the tag magazine 116. The first direction along which the tag magazine 116 is movable relative to the jaws is indicated by the arrow 115 in FIG. 4. The tag magazine 116 is arranged such that the first direction 115 is substantially normal to a longitudinal direction of the jaws 102, 104.

The tag magazine 116 is held on the first handle 110 using a clamp 134 which is mounted on the first handle 110, and which is arranged to engage an outer surface of the first plate 117a. The second plate 117b comprises a planar outer wall (outer surface) 119, which is supported on a planar support surface 136 connected to the first handle 110 (shown in FIG. 7). The planar outer wall 119 is arranged to slide over the support surface 136 when the tag magazine 116 is moved relative to the jaws along the first direction 115. Thus, the tag magazine 116 is effectively held between the clamp 134 and the support surface 136. The clamp 134 and support surface 136 are arranged to maintain a longitudinal position of the tag magazine relative to the lower jaw 102, whilst allowing it to be moved along the first direction 115. The clamp 134 is pivotably mounted on the first handle 110, such that it is pivotable between an open position and a closed. In the configurations shown in FIGS. 1-3, the clamp 134 is in the closed position, i.e. it engages the outer surface of the first plate 117a such that the tag magazine 116 is held between the clamp 134 and the support surface 136 of the first handle 110. The clamp 134 can be pivoted towards the open position, in order to disengage the clamp 134 from tag magazine 116. Thus, in the open position, the tag magazine 116 can be removed from the first handle 110. This facilitates loading of the tag magazine 116 with a strip 900 of tags 126, or replacing and/or repairing the tag magazine 116. The clamp 134 is biased towards the closed position using a spring which is held in the first handle 110 by means of a spring cup.

Of course, in other examples, the clamp 134 need not be pivotable relative to the first handle 110. For example, the clamp may include a resilient portion which is biased towards a position where the clamp 134 engages the tag magazine 116, and which is bendable in order to release the tag magazine from the handle. Tther alternative arrangements may also be used to mount the tag magazine 116 on the first handle 110 such that it is linearly movable relative to the jaws 102, 104.

As the tag magazine 116 is arranged to hold the plurality of tags 126 in a row between the first and second ends of the tag magazine 116, each tag 126 is arranged at a respective position along the first direction 115 following loading of the tags. Accordingly, by moving the tag magazine 116 along the first direction 115, each tag 126 in the strip 900 can be aligned in turn with a tag receiving portion 142 provided in the lower jaw 102. The tag receiving portion 142 of the lower jaw 102 is shaped to receive a tag 126, and hold the tag in place while it is being affixed to an animal's ear. The shape of the tag receiving portion 142 may have a shape that is complementary to the shape of the tag, in order to prevent the tag 126 from moving around in the jaws when it is being affixed to an animal's ear. The tag receiving portion 142 is located directly in the tag affixing gap 106 formed between the jaws 102, 104, such that when a tag is located in the tag receiving portion 142, the jaws can be operated to affix the tag to an animal's ear. When one of the tags 126 in the tag magazine 116 is aligned with the lower jaw 102, there is a direct passageway between the tag magazine 116 and the tag receiving portion 142 of the lower jaw 102, such that the tag 126 can be dispensed from the tag magazine 116 into the tag receiving portion 142. The lower jaw 102 may include an opening 144 and the upper jaw 104 may include an opening 146, such that a tag 126 dispensed from the tag magazine 116 can pass through openings 144 and 146 in order to reach the tag receiving portion of the lower jaw 102.

When the tag magazine 116 is mounted in the applicator 100, the open front side of the tag magazine 116 faces towards the jaws 102, 104 so that tags can be dispensed from the tag magazine 116 into the jaws. The applicator 100 includes a dispensing mechanism 147 which serves to dispense a tag 126 from the tag magazine 116 that is aligned with the lower jaw 102 into the tag receiving portion 142 of the lower jaw 102. The dispensing mechanism 147 includes a pusher 148 which is configured to engage a tag 126 in order to push it out from the tag magazine, and an elongate shaft 150 connected to the pusher 148 for moving the pusher in a longitudinal direction. The longitudinal direction along which the pusher 148 is movable may be (substantially) normal to the first direction 115.

In the example shown in FIG. 7, the shaft 150 includes a first portion 150a which is integrally formed with the pusher 148, and a second portion 150b which is connected to the first portion 150a (e.g. by means of a threaded tip of second portion 150b shown in FIG. 7). The shaft 150 is movable along its length through a channel 152 formed in the first handle 110. The channel 152 is oriented towards the jaws 102, 104, such that the shaft 150 can be moved along the channel 152 towards and away from the jaws 102, 104. In use, the pusher 148 is located on the side of the channel 152 closest to the jaws 102, 104. The pusher 148 may be moved towards and away from the jaws 102, 104 by moving the shaft backwards and forwards along the channel 152. The pusher 148 is shaped so that it does not fit through the channel 152, i.e. it is larger than a cross-section of the channel. This serves to limit the motion of the shaft 150 away from the jaws 102, 104. An end cap 154 is provided on the end of the shaft 150 opposite the end with the pusher 148, in order to limit the motion of the shaft towards the jaws 102, 104. Thus, motion of the shaft along the channel 152 is limited by the pusher 148 at one end and by the end cap 154 at the other end. In the example shown, the shaft 150 is aligned with the tag receiving portion 142 of the lower jaw, i.e. the tag receiving portion 142 is located on a line that passes through a longitudinal axis of the shaft 150.

The back side of the tag magazine 116 (shown in FIG. 6e) includes a plurality of apertures 156 formed therein, with each aperture 156 corresponding to a respective tag receiving space in the tag magazine 116. In other words, each aperture 156 is arranged to be aligned with a respective one of the tags 126 in the strip 900 following loading of the strip 900 into the tag magazine 116. The apertures 156 may be formed between neighbouring pairs of tag alignment features 135. Each aperture 156 is shaped so that the pusher 148 may pass through it, however it does not allow a tag 126 to pass through it. Thus, when one of the tags 126 in the strip 900 is aligned with the tag receiving portion 142, the end cap 154 can be pressed towards the jaws 102, 104 to cause the pusher 148 to pass through the aperture 156 associated with that tag 126 and push the tag 126 from the tag magazine 116 into the tag receiving portion of the lower jaw 102, where the tag 126 can be affixed to an animal's ear. The length of the shaft 150 must be sufficient to enable the tag to be pushed all the way from the tag compartment 122 to the tag receiving portion 142.

The act of pushing the tag 126 with the pusher 148 causes the tag 126 to be separated (disconnected) from the strip 900, leaving the rest of the strip 900 in the tag magazine 116. In particular, pushing the tag 126 with the pusher 148 may cause the one or more connectors between the tag 126 and an adjacent tag in the strip 900 to break, to allow the tag to be pushed into the tag receiving portion 142. When the pusher 148 pushes the tag 126 towards the tag receiving portion 142, an adjacent tag in the strip 900 may engage sides of the jaws defining the openings 144, 146 to prevent motion of the rest of the strip in a pushing direction of the pusher 148. In other words, the openings 144, 146 are shaped so as to allow passage of only one tag at a time, blocking the remaining tags in the strip from being pushed out of the tag magazine 116. Additionally, blocking surfaces 147 (see FIG. 7) may extend on either side of the jaws to block motion of a remaining portion of the strip 900 in the pushing direction of the pusher 148. In the example shown, blocking surfaces 147 are provided on the lower jaw 102 and extend on either side of the opening 144.

Following the dispensing of the tag 126 into the tag receiving portion 142, the pusher 148 may be moved back out of the tag magazine 116 through the aperture 156, so that the dispensing mechanism 147 does not prevent the tag magazine 116 from moving. Then, the tag magazine 116 can be moved in the first direction 115 so that another tag 126 in the strip 900 is aligned with the tag receiving portion 142, so that a new tag can be dispensed.

In the example shown, the dispensing mechanism 147 further includes a spring 157 which is provided on the shaft 150, between an end of the first handle 110 and the end cap 154. The spring 157 presses against the end cap 154, in order to bias the dispensing mechanism 147 towards a withdrawn position where the pusher 148 is withdrawn from the tag magazine 116.

Thus, if the end cap 154 is released following the dispensing of a tag into the jaws, the dispensing mechanism 147 will automatically return to the withdrawn position, so that the tag magazine 116 can be moved. Alternatively the spring 157 may be omitted, in which case it will be necessary to manually move the dispensing mechanism 147 towards the withdrawn position where the pusher 148 is withdrawn from the tag magazine 116. Other mechanisms may also be provided for automatically causing the dispensing mechanism 147 to move towards the withdrawn position. It should be noted that the dispensing mechanism 147 is provided by way of example, and that other alternative dispensing mechanisms may be provided for dispensing the tags from the tag magazine 116.

The tag magazine 116 further comprises a row of indexing features 151 arranged along an edge of the first plate 117a which faces towards the jaws. Each indexing feature 151 is in the form of a notch or groove formed in the edge of the plate 117a. Each indexing feature 151 is associated (e.g. aligned) with a respective one of the tag receiving spaces in the tag magazine 116. Thus, when the strip 900 is loaded in the tag magazine 116, each indexing feature 151 is associated with a respective one of the tags 126 in the strip 900. An engagement member 153 is provided on the upper jaw 104. When the jaws are in the open position (e.g. as shown in FIGS. 1 to 3), the engagement member 153 is arranged to engage the indexing feature 151 associated with one of the tag receiving spaces that is aligned with the tag receiving portion 142 of the jaws. In the example shown, each indexing feature 151 is in the form of a notch with a triangular shape, with the engagement member 153 having a wedge that is shaped to fit the indexing features 151. When the engagement member 153 is engaged with one of the indexing features 151, movement of the tag magazine 116 along the first direction 115 is blocked (or inhibited). In this manner, when the jaws are in the open position, the tag magazine 116 is held in place so that the dispensing mechanism 147 can be operated to dispense a tag 126 into the jaws. The engagement member 153 is arranged to be disengaged from the indexing features 151 when the jaws in the closed position. In this manner, when the handles are squeezed together to close the jaws, the engagement member 153 disengages the indexing feature 151, to allow movement of the tag magazine 116 along the first direction 115.

The applicator 100 is configured such that squeezing the first and second handles 110, 112 together to operate the jaws causes the tag magazine 116 to automatically move (be translated) by a predetermined distance along the first direction 115 relative to the jaws. The predetermined distance corresponds to a spacing between adjacent tags 126 in the strip 900. In this manner, when the tag magazine 116 automatically moves, it goes from a state where a first tag in the strip 900 is aligned with the tag receiving portion 142, to a state where a second, adjacent tag in the strip 900 is aligned with the tag receiving portion 142. Thus, by repeatedly operating the jaws (by squeezing the handles together), each tag 126 in the strip 900 is in turn aligned with the tag receiving portion 142 of the jaws. In other words, the act of affixing a tag to an animal's ear by operating the jaws causes the tag magazine 116 to be moved such that, as soon as the tag has been affixed, another tag 126 in the strip 900 is aligned with the tag receiving portion 142 of the jaws so that a new tag can be dispensed.

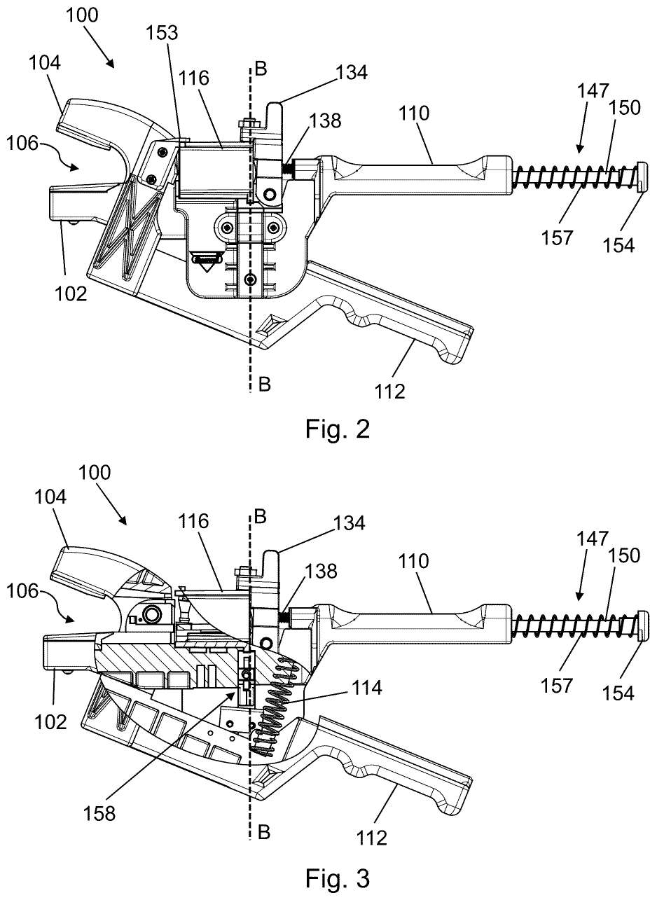

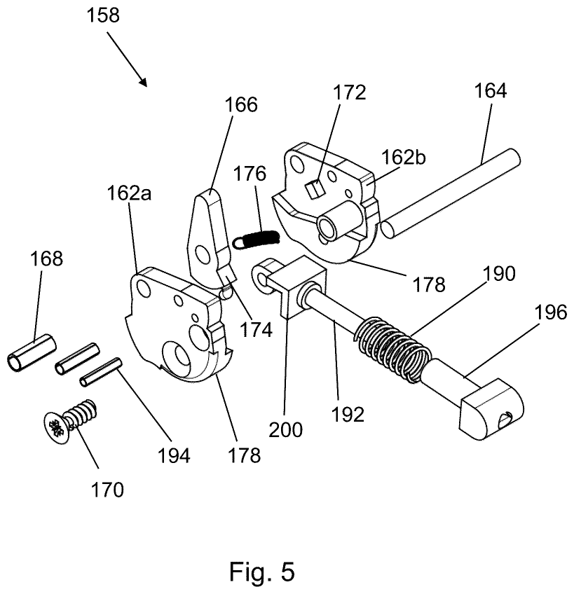

The automatic movement of the tag magazine 116 is achieved using an actuation mechanism 158 which translates relative motion between the handles 110, 112 (and therefore between the jaws 102, 104) into a linear movement of the tag magazine 116 along the first direction 115. An example of a suitable actuation mechanism 158 is shown in FIG. 4, which shows a cross-sectional view of the actuator 100 along the B-B plane depicted in FIG. 2, the B-B plane being parallel to the first direction 115. An exploded view of the actuation mechanism 158 is shown in FIG. 5. The actuation mechanism 158 is located in a body portion of the first handle 110, directly below where the tag magazine 116 is mounted. The tag magazine 116 includes a plurality of teeth 160 disposed along an edge of the plate 117b. The plurality of teeth 160 are arranged in a row along the first direction 115. In the example shown, the teeth 160 extend from a back edge of the plate 117b, however they may be located anywhere on the plate 117b.

The actuation mechanism 158 is configured to engage the teeth 160 of the tag magazine 116 to cause the tag magazine 116 to move in the first direction 115 when the handles 110, 112 are squeezed together. The actuation mechanism 158 includes a cam 162 which is mounted on a pivot 164, the pivot 164 being fixed relative to the first handle 110 such that the cam 162 is pivotable relative to the first handle 110. A pawl 166 is pivotally mounted on the cam 162 via a pivot 168, such that the pawl is pivotable relative to the cam 162. In the example shown, the cam 162 includes two cam body pieces 162a, 162b, and the pawl 166 is held between the two cam body pieces 162a, 162b. The two cam body pieces 162a, 162b are secured together using a screw 170, however in other examples other suitable fastening means may also be used.

The cam body piece 162b includes a stop block 172 arranged to engage a stopping surface 174 of the pawl 166 when the pawl 166 pivots in a first direction (e.g. clockwise in the configuration shown in FIG. 3), such that the stop block 172 prevents the pawl 166 from pivoting further in that direction. A pawl spring 176, which is connected to a hook on the pawl 166 at one end and to the cam 162 at another end, serves to bias the pawl 166 towards a rest position where the stopping surface 174 of the pawl rests against the stop block 172. The pawl 166 protrudes from the cam 162, such that it is engageable with the teeth 160 of the tag magazine 116.

The cam 162 includes a curved surface 178 which is arranged to engage a ramp 180 located on the second handle 112 when the second handle 112 is moved towards the first handle 110. The ramp 180 protrudes upwards from the second handle 112 towards the cam 162. Additionally, the ramp 180 is offset relative to the cam's pivot 164, i.e. the ramp 180 is not aligned with the pivot 164 along the direction of relative motion between the handles 110, 112. In use, when the handles 110, 112 are moved together, the ramp 180 moves towards the cam 162 and pushes against the curved surface 178 of the cam 162. Because of the offset between the pivot 164 and the ramp 180, when the ramp 180 pushes against the curved surface 178 of the cam 162, the ramp 180 causes the cam 162 to pivot about the pivot 164. In the configuration shown in FIG. 4, the ramp 180 is in engagement with the curved surface 178 of the cam 162, such that the cam 162 is pivoted in the anti-clockwise direction relative to the first handle 110.

Of course, the ramp 180 may instead be a protrusion or other suitably shaped surface.

Each tooth 160 of the tag magazine 116 has a short edge 182 and a long edge 184. When the cam 162 pivots due to engagement with the ramp 180, the pawl 166 engages the short edge 182 of a tooth 160 and presses against it, causing the tag magazine 116 to move along the first direction 115. In this configuration, the pawl 166 is firmly held in its rest position by the pawl spring 176 and the stop block 172. As the cam 162 pivots further, the pawl 166 eventually disengages with the tooth 160 and the tag magazine 116 stops moving.

A further mechanism is provided to ensure that the tag magazine 116 stops moving in the correct position, i.e. when a tag 126 in the strip 900 is aligned with the tag receiving portion of the jaws 142. The tag magazine 116 includes a plurality of locating detents 186 formed in an outer surface of the plate 117a, such that each tag receiving space in the tag magazine has a locating detent 186 associated with it. The clamp 134 includes a ball catch 188, which is configured to engage the locating detent 186 associated with a tag receiving space when that tag receiving space is aligned with the tag receiving portion 142 of the jaws. Thus, when the tag magazine 116 moves to a position where a tag receiving space is aligned with the tag receiving portion 142, the ball catch 188 engages the locating detent associated with that tag receiving space and the tag magazine 116 stops moving. When the ball catch 188 engages a locating detent 186, the ball catch 188 resists motion of the tag magazine 116, so that the tag magazine 116 does not freely move. This ensures, for example, that the tag magazine 116 does not move while a tag 126 is being dispensed into the jaws 102, 104. In order to move the tag magazine 116 when the ball catch 188 is engaged in a locating detent 186, it is necessary to apply a force to the tag magazine 116 which is sufficient to overcome the ball catch's resistance to movement. For example, there may be a threshold force below which the tag magazine 116 does not move and the ball catch 188 remains engaged with the locating detent 186. When a force above the threshold force is applied to the tag magazine 116, the ball catch 188 disengages from the locating detent 186 and the tag magazine 116 can move. Therefore, the force applied by the pawl 166 to the tag magazine 116 when it presses against the short edge 182 of a tooth 160 must be sufficient to overcome the ball catch's resistance to movement in order to cause the tag magazine 116 to move. Of course, other mechanisms than the ball catch 188 and the locating detents 186 shown may be used to accurately control the movement and positioning of the tag magazine 116.

The cam 162 is pivotable relative to the first handle 110 between an operating position and a disengaged position. In the operating position, the pawl 166 is located adjacent to the short edge 182 of a tooth 182, such that when the handles 110, 112 are squeezed together the cam 162 will pivot and cause the pawl 166 to press against the short edge 182 of that tooth 160. In the disengaged position, the cam 162 is pivoted relative to the first handle 110 such that the pawl 166 is disengaged from the short edge 182 of the tooth. The cam 162 is biased towards the operating position, such that when a user releases the handles 110, 112, the cam automatically returns to the operating position. As the cam 162 returns from the disengaged position to the operating position, the pawl 166 may come into contact with the long edge 184 of a tooth 160, causing the pawl 166 to pivot away from its rest position against the stop block 172. Once the pawl 166 has cleared the long edge 184 of the tooth 160, the pawl 166 returns to its rest position due to the restoring force of the pawl spring 176.

In the example shown, the cam 162 is biased towards the operating position by means of a cam return spring 190. The cam return spring 190 is held on an arm 192 which is connected to the cam 162 via a pivot 194, which enables the arm 192 to pivot relative to the cam 162 when the cam 162 pivots about pivot 168. An end piece 196 is connected to the arm 192 by the cam return spring 190, wherein an end of the arm 192 is received inside the end piece 196 and is slidable within the end piece 196, The end piece 196 may be a sleeve. The end piece 196 is received in a cavity 198 formed in a side wall of the first handle 110. The cam return spring 190 is arranged such that when the cam 162 pivots towards the disengaged position, the cam return spring 190 is compressed between the end piece 196 and a stopping surface on the arm 192. As the cam 162 pivots, the arm 192 may itself pivot relative to the cam 162. Additionally, the end piece 196 may slide relative to the arm 192, due to the change in distance between the pivot 194 and the cavity 198 in the handle as the cam 162 pivots. Then, when the handles 110, 112 are moved apart (e.g. due to the main spring 114), the cam 162 returns to the operating position as the cam return spring 190 extends from its compressed state.

The arm 192 includes a lip 200 which is configured to rest against a side of the cam 162 when the cam is in the operating position. The lip 200 serves to prevent the cam 162 from pivoting beyond the operating position due to the restoring force of the cam return spring 190. Thus, when the cam 162 is in the operating position, it is held in place by the lip 200 under the restoring force of the cam return spring 190.

The actuation mechanism 158 and teeth 160 of the tag magazine 116 act as a ratchet-like system, as they enables controlled movement of the tag magazine 116 in one direction (e.g. right to left in FIG. 4), whilst preventing movement of the tag magazine 116 in the opposite direction. For example, in the configuration shown in FIG. 4, if one attempts to move the tag magazine 116 left to right, a short edge 182 of a tooth 160 will engage the pawl 166, forcing it towards its rest position where it rests against the stop block 172. This will in turn force the cam 162 to pivot to its operating position, where further pivoting of the cam 162 is prevented by the lip 200 on arm 192. Then, as both the pawl 166 and the cam 162 are prevented from pivoting any further (by the stop block 172 and the lip 200, respectively), the short edge 182 of the tooth 160 is blocked by the pawl 166 and the tag magazine 116 cannot move any further. Thus, by ensuring that the tag magazine 116 can only move in a single direction, it is possible to ensure that the animal identification tags 126 are applied in the correct order.

Of course, other ratchet-like systems for enabling controlled movement of the tag magazine 116 in one direction (e.g. right to left in FIG. 4), whilst preventing movement of the tag magazine 116 in the opposite direction, may be provided instead.

As mentioned above, the jaws 102, 104 are operable to affix an animal identification tag 126 which has been dispensed from the tag magazine 116 into the tag receiving portion 142 of the lower jaw 102. When a tag 126 is located in the tag receiving portion 142 of the lower jaw 102, the tag 126 may be affixed to an animal's ear by placing the ear in the tag affixing gap 106 between the jaws 102, 104, such that the male engagement portion 130 of the tag 126 is located on one side of the ear, and the female engagement portion 128 is located on the opposite side of the ear. Then, squeezing the handles 110, 112 together causes the tag affixing gap 106 to close over the ear. This causes the male portion 130 of the tag 126 to be driven through the ear and to engage the female portion 128, such that the tag 126 is securely affixed to the animal's ear.

A description of how the applicator 100 is operated is given below, setting out a sequence of events that take place when the applicator 100 is operated.

First, the tag magazine 116 is loaded with a plurality of a plurality of animal identification tags 126 that are connected together in a strip 900, such that the plurality of animal identification tags 126 is arranged in a row between the first end (first sidewall 120) and the second end (second sidewall 122) of the tag magazine 116. The tag magazine 116 is then mounted on the applicator 100 by pulling back the clamp 134, and releasing it once the tag magazine 116 is in place, so that the clamp 134 engages the outer surface of the plate 117a of the tag magazine 116.

Then, the handles 110, 112 may be squeezed together in order to cause the tag magazine 116 to move by means of the actuation mechanism 158. As the ramp 180 engages the curved surface 178 on the cam 162, the cam 162 pivots, causing the pawl 166 to press against the short edge 182 of a tooth 160 on the tag magazine 116 and cause it to move along the first direction 115. When the ball catch 188 engages a locating detent 186 on the tag magazine 116, the tag magazine 116 stops moving a position where one of the tags 126 in the strip 900 is aligned with the tag receiving portion 142 of the lower jaw 102. Subsequently, the handles 110, 112 may be released, causing the cam 162 to return to is operating position due to the cam return spring 190.

The dispensing mechanism 147 may then be operated to dispense the tag 126 that is aligned with the tag receiving portion 142 into the tag receiving portion of the lower jaw 102. To do this, the end cap 154 is pressed towards the jaws 102, 104, causing the pusher 148 to extend through the aperture 156 of the tag magazine 116 and push the tag 126 out of the tag magazine 116 and into the tag receiving portion 142 of the lower jaw 102. As discussed above, pushing the tag 126 with the pusher 148 causes the tag to become separated from the strip 900, leaving the rest of the strip 900 in the tag magazine 116. The end cap 154 may then be released, such that the pusher 148 is withdrawn from the tag magazine 116 under action from the spring 157.

When the animal identification tag 126 is pushed out of the tag magazine 116, the animal identification tag 126 springs open due to the resilience of the connection portion 132. In this configuration, there is a gap between the female portion 128 and the male portion 130. This enables an animal's ear to be inserted between the male and female engagement portions, so that the animal identification tag can be affixed to the animal's ear by operating the jaws.

Thus, an animal's ear may be placed in the tag affixing gap 106 between the jaws 102, 104, and the handles 110, 112 may be squeezed together to affix the tag 126 to the animal's ear in the manner described above. Squeezing the handles 110, 112 together causes a next tag 126 in the strip 900 to be aligned with the tag receiving portion 142, such that the next tag can be dispensed into the tag receiving portion as soon as the previous tag has been affixed to the animal's ear. This cycle may be repeated until all of the tags 126 in the strip 900 have been dispensed from the tag magazine 116, following which the tag magazine 116 may be reloaded, or replaced with another fully-loaded tag magazine.

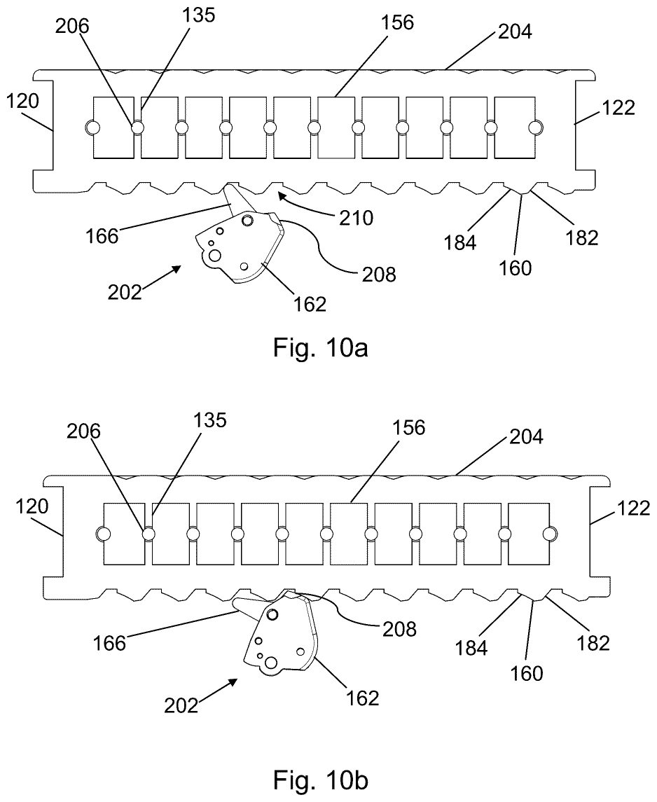

FIGS. 10a and 10b illustrate a cam assembly 202 and a tag magazine 204 which may be used in a tag applicator according to the disclosure. For example, the pawl assembly 202 and the tag magazine 204 may be used in the tag applicator 100 described above. For illustration purposes, other components of the tag applicator are omitted from FIGS. 10a and 10b.

The tag magazine 204 has an analogous structure to the tag magazine 116 described above. Accordingly, features of the tag magazine 204 corresponding to features of the tag magazine 116 described above are indicated in FIGS. 10a and 10b with the same reference numerals as for tag magazine 116, and are not described again. The tag magazine 204 additionally includes a plurality of retaining features 206 for retaining the plurality of tags 116 in the tag magazine 204. The retaining features 206 may be in the form of protrusions (or bumps, notches) on the tag alignment features 135. The retaining features 206 are arranged such that, when the strip 900 of tags 126 is loaded into the tag magazine 204 via its open side, the (bent) connection portion 132 of each tag 126 is pushed past a respective pair of retaining features 206 located on either side of the tag 126. This may involve applying a force to the tag 126 to cause the connection portion 132 to deform and pass over the respective retaining features 206. Thus, following insertion, the tags 126 are prevented from falling out of the open side of the tag magazine 204 via engagement between the retaining features 206 and the connection portions 132 of the tags 126. Then, in order to dispense one of the tags 126, the dispensing mechanism 147 will need to apply a force to the tag 126 to push it past the retaining features 206, e.g. the applied force will need to cause the connection portion 132 to deform or bend to pass over the retaining features 206.

The pawl assembly 202 includes a cam 162 and a pawl 166, which operate as described above in relation to the tag applicator 100. In particular, moving the handles 110, 112 together causes the cam 162 to pivot such that the pawl 166 engages one of the teeth 160 on the tag magazine 204 to push the tag magazine 204 in the first direction.

In addition to the features described in relation to tag applicator 100, the cam 162 in FIGS. 10a, 10b includes a blocking surface 208 which is arranged to engage the teeth 160 when the jaws 102, 104 are in the closed position, to prevent movement of the tag magazine 204 relative to the jaws. In more detail, the blocking surface 208 on the cam 162 is arranged to fit in a gap 210 between adjacent teeth 160. Thus, a shape of the blocking surface 208 may be complementary to a shape of the gap 210, to provide a close fit between the blocking surface 208 and the teeth 160. By engaging teeth on either side of the gap 210, this effectively prevents forwards and backwards motion of the tag magazine 204 along the first direction. The blocking surface 208 includes a first portion and a second portion that are arranged to engage respective teeth on either side of the gap 210.

FIG. 10a shows the cam assembly 202 in a first configuration, where the jaws 102, 104 are being moved towards the closed position. In this configuration, the cam assembly 202 is pivoted such that the pawl 166 engages a first one of the teeth on the tag magazine 204, to push the tag magazine 204 in the first direction. In FIG. 10b, the jaws 102, 104 are in the closed position, with the cam 162 maximally pivoted such that the blocking surface 208 is engaged in the gap 210 between adjacent teeth, to thereby block movement of the tag magazine 204 along the first direction. The gap 210 in which the blocking surface 208 is engaged is defined between a second tooth and a third tooth, the second tooth being adjacent to a first tooth which was engaged by the pawl 166 during closing of the jaws 102, 104. With the arrangement shown in FIGS. 10a and 10b, the cam assembly 202 remains in continuous contact with the tag magazine 204 as the jaws 102, 104 are moved together and when the jaws 102, 104 are closed. In particular, the pawl 166 contacts one of the teeth 160 during closing of the jaws 102, 104, and the blocking surface 208 contacts the tag magazine 204 when the jaws 102, 104 are closed. This provides accurate and controlled movement of the tag magazine 204, and avoids slipping or play in a position of the tag magazine 204 with respect to the jaws 102, 104.

As can be seen, a shape of the teeth 160 is different in the tag magazine 204 compared to those in the tag magazine 116. For example, a shape of the teeth 160 adapted in the tag magazine 204 may be adapted to provide a large contact area between the blocking surface 208 and the teeth 160. Thus, in the tag magazine 204, the short edge 182 of each tooth 160 is slanted relative to a normal direction, the normal direction being perpendicular to the first direction. Slanting of the short edge 182 of the tooth 160 may contribute to increasing contact area between the tooth 160 and the blocking surface 208. Additionally, a portion of the blocking surface 208 which is arranged to engage the long edge 184 of one of the teeth may be curved. A curvature of the portion of the blocking surface 208 which is arranged to engage the long edge 184 of the tooth may match (be complimentary to) a curvature of the long edge of the tooth. This may facilitate pivoting the cam 162 to bring the blocking surface into engagement with the teeth on either side of the gap 210.

Other embodiments of the invention may differ from the embodiments described herein. For example, in other embodiments, the jaws may have a different structure, and the mechanism for operating the jaws may be different, e.g. a trigger may be used to move the jaws instead of a pair of handles. Alternative mechanisms for moving the tag magazine may be provided, for example a system of gears. In some embodiments, the movement of the tag magazine may be decoupled from the movement of the jaws, i.e. operating the jaws does not cause movement of the tag magazine. Various operations of the applicator may be partially or fully automated. For example, the dispensing mechanism may automatically dispense a new tag into the jaws as soon as a tag has been affixed to an animal's ears.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An applicator for animal identification tags, the applicator comprising:
a tag magazine configured to hold a plurality of animal identification tags that are connected together in a strip, such that the plurality of animal identification tags is arranged in a row between a first end and a second end of the tag magazine;
a pair of jaws arranged to receive one of the plurality of animal identification tags dispensed from the tag magazine, the jaws being operable to affix the received animal identification tag to an animal's ear by engaging a male portion and female portion of the animal identification tag through the animal's ear,
wherein the tag magazine is movable relative to the jaws along a first direction linking the first end and the second end of the tag magazine, to sequentially align each one of the plurality of tags in the magazine with a tag receiving portion of the jaws; and
a dispensing mechanism operable to dispense, from the tag magazine into the tag receiving portion of the jaws, one of the plurality of animal identification tags that is aligned with the tag receiving portion of the jaws.

2. An applicator according to claim 1, wherein the tag magazine comprises a planar outer wall arranged to engage a support surface of the tag applicator and to slide over the support surface when the tag magazine is moved relative to the jaws.

3. An applicator according to claim 1, wherein the tag magazine comprises a pair of parallel plates between which a space for receiving the plurality of animal identification tags is defined.

4. An applicator according to claim 1, wherein the tag magazine comprises a first inner surface and a second inner surface which are mutually opposed, and between which the plurality of animal identification tags is received in use, wherein the first inner surface is arranged to contact a male portion of each of the animal identification tags, and the second inner surface is arranged to contact a female portion of each of the animal identification tags.

5. An applicator according to claim 1, wherein the tag magazine is arranged to hold the plurality of animal identification tags such that, for each tag, the male portion is partially engaged in the female portion.

6. An applicator according to claim 1, wherein the tag magazine comprises a tag alignment feature arranged to sit between adjacent animal identification tags in the strip, such that a connector between the adjacent animal identification tags extends across the tag alignment feature.

7. An applicator according to claim 6, wherein:
the tag magazine comprises a first inner surface and a second inner surface which are mutually opposed, and between which the plurality of animal identification tags is received in use, wherein the first inner surface is arranged to contact a male portion of each of the animal identification tags, and the second inner surface is arranged to contact a female portion of each of the animal identification tags,
the tag alignment feature comprises a first portion extending on the first inner surface and a second portion extending on the second inner surface,
the first portion and the second portion of the alignment feature are connected together in a first region, and
there is a gap between the first portion and the second portion of the alignment feature in a second region.

8. An applicator according to claim 1wherein the dispensing mechanism comprises a pusher operable to push the animal identification tag that is aligned with the tag receiving portion to separate the animal identification tag from the strip and dispense the animal identification tag into the tag receiving portion of the jaws.

9. An applicator according to claim 8, further comprising a blocking surface arranged to engage an animal identification tag in the strip adjacent to the animal tag that is aligned with the tag receiving portion, to thereby block motion of a remaining portion of the strip in a pushing direction of the pusher when the pusher is operated.

10. An applicator according to claim 1, wherein:
the tag magazine comprises a plurality of tag receiving spaces, each tag-receiving space being configured to hold a respective one of the plurality of animal identification tags,
the tag magazine comprises plurality of indexing features, each indexing feature being associated with a respective one of the tag receiving spaces, and
the applicator comprises an engagement member, the engagement member being configured to, when the jaws are in an open position, engage the indexing feature associated with one of the tag receiving spaces that is aligned with the tag receiving portion of the jaws.

11. An applicator according to claim 1, further comprising an actuation mechanism, the actuation mechanism being configured to, when the jaws are operated to affix a first one of the plurality of animal identification tags to an animal's ear, cause the tag magazine to move in the first direction to align a second, adjacent one of the plurality of animal identification tags with the tag receiving portion of the jaws.

12. An applicator according to claim 1, further comprising:
a plurality of animal identification tags, the animal identification tags being connected together in the strip,
wherein the tag magazine holds the strip between the first end and the second end of the tag magazine.

13. A tag magazine for an animal identification tag applicator, comprising:
a holder for holding a plurality of animal identification tags that are connected together in a strip, such that the plurality of animal identification tags is arranged in a row between a first end and a second end of the tag magazine; and
a plurality of teeth extending in a first direction linking the first end and the second end of the tag magazine, wherein the plurality of teeth is configured to engage an actuation mechanism of the tag applicator for moving the tag magazine relative to jaws of the tag applicator along a first direction linking the first end and the second end of the tag magazine.

14. A method of operating the tag applicator according to claim 1, the method comprising:
loading the tag magazine with a plurality of animal identification tags that are connected together in a strip, such that the plurality of animal identification tags is arranged in a row between the first end and the second end of the tag magazine;
operating the dispensing mechanism to dispense a first one of the plurality of animal identification tags into the tag receiving portion of the jaws; and
moving the tag magazine relative to the jaws in the first direction, to align a second, adjacent one of the plurality of animal identification tags with the tag receiving portion of the jaws.
